(19) United States
(12) Patent Application Publication
(10) Pub. No.: US 2006/0125907 A1
(43) Pub. Date: Jun. 15, 2006

(54) Image recording apparatus

(76) Inventor: Akira Yamano, Tokyo (JP)

Correspondence Address: CANTOR COLBURN, LLP, 55 GRIFFIN ROAD SOUTH, BLOOMFIELD, CT, 06002, US

(21) Appl. No.: 11/294,004

(22) Filed: Dec. 5, 2005

(30) Foreign Application Priority Data
Dec. 9, 2004 (JP) JP2004-356857

(51) Int. Cl. B41J 2/385; G03G 9/08

(52) U.S. Cl. 347/155

(57) ABSTRACT

In medical image recording apparatus, exposure section forms a latent image on film by exposing film based on a testing exposure signal for correction of density characteristics of the leading edge and/or the trailing edge of film, and heat development section heat-develops to visualize the latent image and records it on film, and density measurement section measures the density characteristics of the testing exposure signal on the heat-developed film and then, shading correction section determines the correction areas of the leading edge and/or the trailing edge of film based on the result of the density measurement and corrects the density characteristics of the leading edge and/or the trailing edge of film for the correction areas at the image recording stage of a diagnostic image data.

This application is based on Japanese Patent Application No. 2004-356857 filed on Dec. 9, 2004 in Japanese Patent Office, the entire content of which is hereby incorporated by reference.

### BACKGROUND OF THE INVENTION

This invention relates to an image recording apparatus for forming images on a recording medium which comprises a photosensitive and heat-sensitive recording material.

An image recording apparatus has been used, in which images were recorded on a film formed from a photosensitive and a heat sensitive material (called a photo and thermally sensitive material hereinafter) (See Document 1 for example). Latent images are formed using a laser beam or the like on the film comprising the photo and thermally sensitive material and then the film is heated to conduct development. This is sometimes called a dry imager, because it uses a dry method which does not require chemical development processes which uses developing solutions or the like.

A system which may be used as this type of dry imager heat development mechanism is one in which film is brought in contact with a drum-shaped heat roller which has a built-in heater, to perform heat development while rotating the heat roller and conveying the film.

The amount of heat applied to the film at the time of heat development as well as the time of the heat development directly affects the shading of the image formed on the film, but the heater which is a heat source for the heat roller generally has a certain heat distribution, and it is difficult for the heat distribution to be even over the entire surface of the heat roller. This results in unevenness in temperature along the axial direction of the heat roller, and the temperature unevenness also occurs in the conveyance direction of the film.

In the prior art, in order to prevent this type of density unevenness on the film caused by temperature unevenness, or so called shading, methods have been proposed in which correction information for shading correction is created in advance, and at the time of formation of the latent image to be outputted, this correction information is used for correcting exposure amount corresponding to the density of the image to be outputted and then exposure and heat development of the film is performed (See Patent Documents 1 and 2 for example). In the shading correction method described in Patent Document 2, exposure and heat development are performed based on test data such that the entire film surface has the same density value, and the density of the film that has been developed is measured using a density sensor. Correction information is then created to eliminate the density unevenness based on the results of the density measurements.

[Patent Document 1] Unexamined Japanese Patent Application Publication No. Tokkai hei6-233134

[Patent Document 2] Unexamined Japanese Patent Application Publication No. Tokkai 2003-136782

It is to be noted that the film used in image formation is generally manufactured by being cut in a predetermined size from a long film roll. Thus when the film sizes are different, processing methods in the manufacturing process such as the method for coating emulsion and the cutting method and the like are different, and the extension and/or curl direction also are different.

Furthermore, opposing rollers are disposed at the outer periphery of the heat roller and in the case of the opposing roller system in which a pushing force against the drum is applied to the film using the opposing rollers so that the film is brought into contact with the heat roller, if the pushing force that is applied to the film is appropriate, the contact surfaces between the heat roller and the opposing rollers are parallel to the axis of the drum. However, if the pushing force on the opposing rollers is increased in order to improve the contact, distortion of the opposing rollers occurs and excessive pushing force is applied to both ends of the opposing rollers and in the vicinity thereof. On the other hand, the pushing force in the middle of the opposing roller along the axis is reduced and because the thermal conductivity is reduced on the area, density unevenness between the end portion and the middle portion along the axis occurs.

In addition, the time for heat development and the time for the subsequent cooling sometimes change depending on the film conveying mechanism, and as a result, density unevenness sometimes occurs.

In particular, when the film is conveyed and is moved forward to the heat roller, the temperature of the leading portion that contacts the heat roller is high, but the temperature of the remaining portion that is not in contact is low, and thus as shown in FIG. 13, distortion of the film due to temperature unevenness occurs and there is density unevenness and the contact ratio with the heat roller at the leading portion of the film in the conveyance direction and at remaining portion changes and density unevenness occurs.

In addition, the film is sequentially conveyed from one opposing roller to the next opposing roller by the rotation of the heat roller, but when the film goes to the opposing roller, the leading edge of the film collides with the opposing roller and is involved so as to be wound thereon. Until the time when it is wound up, that is at the time of collision, the leading edge of the film is not in contact with the heat roller and thus the amount of heat transmission is low. As a result, the leading edge of the film has a portion with reduced density corresponding to the pitch of the opposing rollers.

In addition, there is a tendency for the density of the film to be reduced to the extent that the cooling speed is fast or to the extent that the amount of cooling is large. The film that has been heated by the heat roller is further conveyed and taken away from the heat roller and then reaches the guide plate. However, the leading edge of the film in the direction of conveyance receives resistance from the guide plate and forms trace f1. That is to say, the other portions come in contact with the guide plate relatively earlier than the leading edge of the film. Because the cooling amounts from cooling due to contact of the film with the guide plate and cooling due to the atmosphere (air) are different, density unevenness occurs between the leading edge and the other portions.

In addition, as shown in FIG. 13, in the case where the film conveyance mechanism is formed as a structure providing pulling force by means of the pair of guide rollers disposed at the opposite position of the guide plate from the heat roller to further convey the film that has reached the guide plate, in order to prevent creasing of the film, the rotation speed of the conveying roller v1 is often greater than the rotation speed of the heat roller v2. In this case, as the leading edge is conveyed, the film is pulled in the conveyance direction at a speed that is higher than the rotation speed of the heat roller and thus gradually switches its trace from trace f1 to traces f2 and f3 shown in FIG. 13, and then the film gradually lifts up from the guide plate and the most part of the trailing edge side is cooled by air. Thus, due to the difference in the cooling process at the leading edge portion and the trailing edge portion, density unevenness occurs.

Furthermore, there is some difference in the pattern of the density unevenness at the leading edge portion and the trailing edge portion described above due to the aspect ratio of the film. For example, as shown in FIG. 14, in the case of a large size film such as a 14×17 inch size film and a small size film such as 8×10 inch size film, because the length in the width direction (exposure main scanning direction) is different, as shown in FIG. 14, the effect of pushing force of the opposing rollers on the film also differs and the pattern of density unevenness also changes. Also, in the case where the conveyance speed toward the heat roller is faster than the rotation speed of the heat roller, because the length in the conveyance direction of the 14×17 inch size film is longer compared to the 8×10 inch size film, the film tends to be more distorted to form a loop at the point where it gets involved with the heat roller. As a result, the pattern with which density unevenness occurs at the leading edge portion is different from that of the 8×10 inch size film.

In this manner, despite the fact that the pattern with which density unevenness occurs is different according to the difference in film size, the same correction information was used for all film sizes, and thus suitable correction could not be carried out.

### SUMMARY OF THE INVENTION

The object of this invention is to perform suitable shading correction in accordance with the film size.

The apparatus of Item 1 of the invention comprises: a film retaining device which is capable of retaining at least one size of a sheet film from among a plurality of sizes of sheet films that are formed by coating an emulsion formed from a photosensitive and a heat-sensitive recording material onto a support; an exposure means which performs scanning and exposure on the film based on image data to be outputted and forms latent images; a heat development means for heating the exposed film and making the latent image formed on the film visible; and a shading correction means for performing density correction for the output image data such that a density level of the image made visible on the film is even over the entire film surface, wherein the shading correction means performs a different density correction for each film size.

The apparatus of Item 2 of the invention is the image recording apparatus of Item 1 wherein, the shading correction means corrects density in the conveyance direction of the film in the heat development means.

The apparatus of Item 3 of the invention is the image recording apparatus of Item 1 or 2 wherein, the heat development means comprises a cylindrical heat roller on the periphery of which film is wound and heated; and a plurality of opposing rollers which press the film wound on the periphery of the heat roller against the heat roller.

### BRIEF DESCRIPTION OF THE DRAWINGS

FIG. 1 is a schematic view showing a structure of a medical image recording apparatus of an embodiment related to the invention.

FIG. 2 is a schematic view showing a structure of density measurement section 7.

FIG. 3 is a diagram showing an internal structure of medical image recording apparatus 1α.

FIG. 4 is a diagram explaining occurrence factor of density unevenness.

FIG. 5 is a diagram explaining occurrence factor of density unevenness.

FIG. 6 is a diagram explaining occurrence factor of density unevenness.

FIG. 7 is a diagram showing an example of testing exposure pattern P.

FIG. 8 is a flowchart showing calibration process.

FIG. 9 is a diagram showing an example of density measurement for the leading edge and the trailing edge of film 1.

FIG. 10 is a diagram showing an example of calculation of the relationship between the position from the leading edge of film 1 and the exposure amount.

FIG. 11 is a diagram showing an example of calculation for a correction table of leading edge.

FIG. 12 is a flowchart showing the image recording process.

FIG. 13 is a diagram explaining an occurrence factor of density unevenness on a conventional image recording apparatus.

FIG. 14 is a diagram explaining the difference of heat developing condition due to the difference of film size.

### DETAILED DESCRIPTION OF THE PREFERRED EMBODIMENT

To begin with, the structure will be explained.

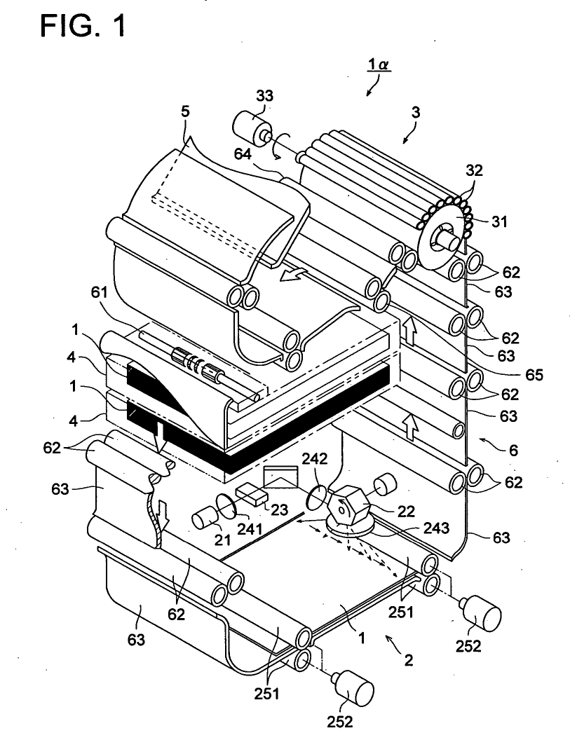

The structure of medical image recording apparatus 1α of the embodiment is shown in FIG. 1.

As shown in FIG. 1, medical image recording apparatus 1α is composed of exposure section 2 forming a latent image by irradiating laser for exposure on film 1 of a heat developable photosensitive type on which a photosensitive layer is formed on the surface, heat development section visualizing the latent image by heat-developing the exposed film 1, film storage 4 storing unexposed film 1, film exit 5 on which developed film 1 is ejected after exposure and film conveyance section 6 transporting film 1 through film storage 4, exposure section 2, heat development section 3 and film exit 5 in this order.

Film storage 4 is composed of a tray containing a plurality of piled unexposed films 1. In the embodiment, two film storages 4 are installed to store films 1 of different sizes. When all the films 1 in film storage 4 are used up, a new film package is loaded by pulling out the trays.

Exposure section 2 is mainly composed of laser emitter 21 emitting a laser beam to be irradiated on film 1, scanning section 22 scanning the laser beam on the film 1 and illumination-intensity changing section 23 changing the intensity of illumination of a laser beam scanned on film 1 according to the data of image to be visualized. The laser emitter 21 emits a laser beam in the range of photosensitive wavelength of film 1, and semiconductor laser of emission wavelength of, for example, 810 nm can be used. For the scanning section 22, a polygon mirror is used in the embodiment. When a laser beam is irradiated on the polygon mirror while it is rotating at a prescribed speed, the laser beam is scanned in the lateral direction of the film 1 in a prescribed cycle.

The exposure section 2 has a precise feeding mechanism transferring film 1 while being exposed, in the lengthwise direction precisely. Because a laser beam is scanned in the lateral direction by the polygon mirror and film 1 is transferred in the lengthwise direction by the precise feeding mechanism, the laser beam is scanned in the prescribed area on the film 1.

The illumination-intensity changing section 23 is composed of a light modulation element in the present embodiment. As a light modulation element, an acousto-optic element (AOM), for example, can be used. The acousto-optic element generates diffracted light by a supersonic wave and modulates the intensity of the diffracted light by adjusting the intensity of the supersonic wave. Diagnosis image data to be outputted (hereinafter referred to as image data) are inputted from the outside through interface section 160 (not illustrated in FIG. 1) and are stored in memory 150 (not illustrated in FIG. 1). Image data in the memory 150 are read and sent to the illumination-intensity changing section 23. The illumination-intensity changing section 23 changes irradiation of a laser beam according to the image data when the laser beam is scanned on the film 1. As a result, the film 1 is exposed to make an image according to the image data.

The laser optical system is composed of light condensing lens 241 condensing a laser beam on illumination-intensity changing section 23, collimator lens 242 restoring the laser beam transmitted from illumination-intensity changing section 23 to a parallel beam and fθ lens 243 condensing a laser beam reflected on the polygon mirror to be a thin beam on film 1 regardless of a difference of the distance to film 1.

The precise feeding mechanism is composed of a pair of feeding rollers 251 feeding film 1 while the film 1 is pinched by the rollers and servomotor 252 driving feeding rollers 251. Servomotor 252 synchronizes with scanning section 22 to drive feeding roller 251 so that film 1 is moved forward at a prescribed speed.

Heat development section 3 conducts heat development in the embodiment. Specifically, the heat development section 3 is composed of heat roller 31 and opposing rollers 32 which add pressing force to film 1 to bring it into close contact with heat roller 31. As shown in FIG. 1, the heat roller 31 is a cylindrical roller having a relatively large diameter, and a heater is installed inside the heat roller 31. The opposing rollers 32 are slender with respect to the heat roller and cylindrical, and a plurality of them are provided equally spaced (a prescribed pitch), along the circumference of the heat roller 31.

The heat roller 31 is equipped with motor 33 for driving (for transportation). Exposed film 1 is pinched between the heat roller 31 and the opposing rollers 32. When heat roller 31 is rotated by driving motor 33, the film 1 is fed by heat roller 31 and each of opposing rollers 32 while the film 1 is pushed against the circumferential surface of the heat roller 31. The film 1 is developed by the heat from heat roller 31 at this time.

Film conveyance section 6 is composed of pick-up mechanism 61 feeding out film 1 by picking it up from a tray, plural paired pinch rollers 62 feeding film 1 by pinching it, an unillustrated motor for transportation which drives pinch roller 62, guide plates 63, 63A and 63B (63A and 63B are not illustrated in FIG. 1) guiding the transportation of film 1, guide roller 64 guiding film 1 after heat development and transporting roller 65 guiding film 1 after heat development. In the conveyance section 6, for example, for members contacting film 1 such as pinch rollers 62, special surface treatment is applied or a suitable material is selected so that film 1 may not be damaged or a stained. Film exit 5 is composed of a tray arranged on the upper surface of medical image recording apparatus 1α in this embodiment. Developed film 1 is ejected on the tray after transportation by film conveyance section 6.

In the medical image recording apparatus 1α, density measurement section 7 (not illustrated in FIG. 1) which measures, after development, the density of a prescribed portion of film 1 (hereinafter referred to as density measurement portion) exposed by a predetermined light amount, is equipped on the transportation passage between heat development section 3 and film exit 5. According to the result of measurement of the density measurement section 7, the calibration control is conducted.

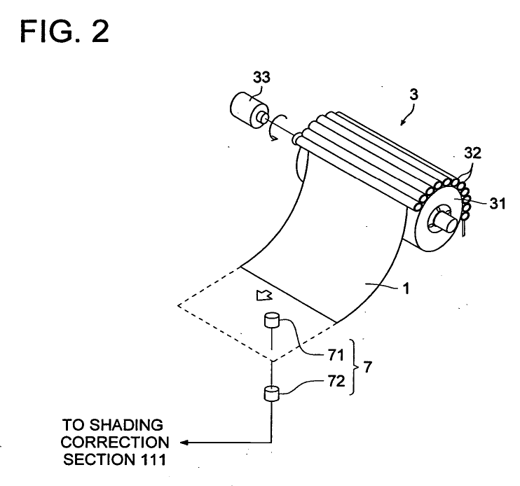

An explanation will be given on this point referring to FIG. 2. A general structure of the density measurement section 7 is shown in FIG. 2. The density measurement section 7 is composed of light emitter 71 emitting light toward the density measurement portion of film 1 after development and light receptor 72 receiving light coming from light emitter 71, which has penetrated through the density measurement portion of the film.

The density measurement section 7 is installed on a position, where the heated film 1 has cooled down to under the prescribed temperature and the development process has stopped to determine the density, on the downstream side of the heat development section 3 shown in FIG. 2. A film passage detecting sensor is installed between heat development section 3 and density measurement section 7, and the density measurement starts with a prescribed time lag after the detection of the passage of film 1. The result of the measurement (output of density detecting transmission sensor 72) is transmitted to shading correction section 111 as a digital signal via AD converter.

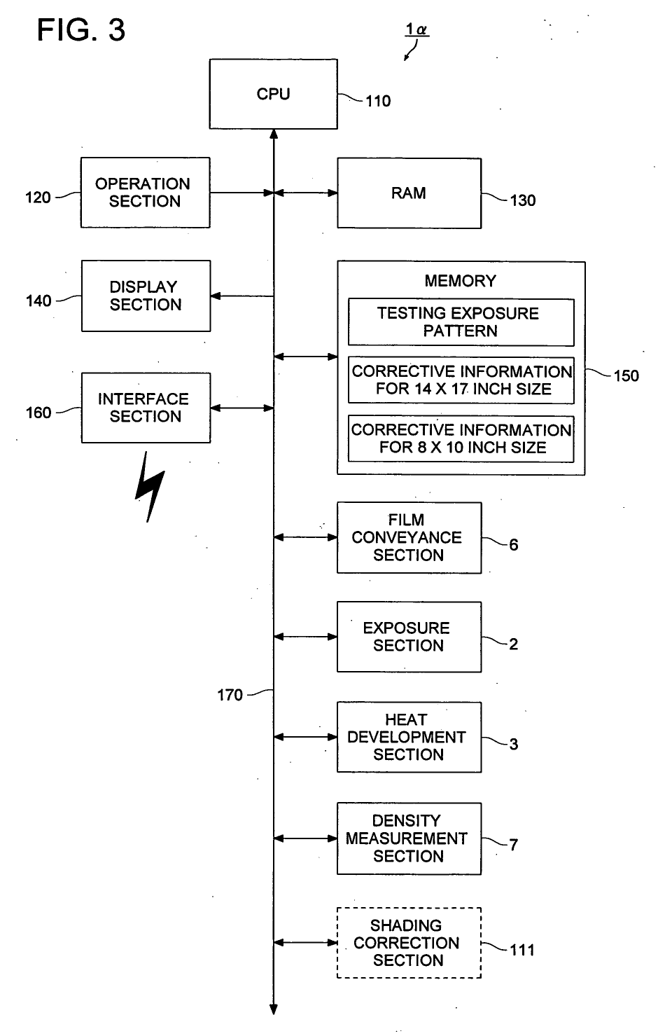

Next, an explanation about the controlling structure of medical image recording apparatus 1α will be given referring to FIG. 3. The internal structure of the medical image recording apparatus 1α is shown in FIG. 3. The medical image recording apparatus 1α is composed of CPU (Central Processing Unit) 110, operation section 120, RAM (Random Access Memory) 130, display section 140, memory 150, interface section 160, film conveyance section 6, exposure section 2, heat development section 3 and density measurement section 7, and each part is connected to bus 170.

The CPU 110 carries out a controlling of each part in medical image recording apparatus 1α. CPU 110 develops a designated program among system programs and application programs of each type stored in memory 150 to RAM 130 and carries out process of each type in cooperation with a program developed in RAM 130. The main part performing the procedure is represented by shading correction section 111.

The operation section 120 is a touch panel operating section structured integrally with, for example, display section 140, and accepts touch input from users at display section 140, and transmits the input signal to CPU 110. Operation section 120 can be an independent operating section from display section 140 with keys of each type. RAM 130 has a work area storing said designated program, indication of input, input data and the result of process, and it stores information temporally.

The display section 140 is equipped with a display screen section such as LCD (Liquid Crystal Display) and, for example, structured as a touch panel display with operation section 120. Display section 140 displays a screen image according to display signal coming from CPU 110.

The memory 150 previously stores programs and data of each type and can be written in, and composed of, for example, ROM (Read Only Memory), a flash memory and a hard disk. Interface section 160 is structured by a network card for communicating with outer apparatuses and so on and deals communication with the outer apparatuses.

Memory 150 stores a testing exposure pattern for calibration to eliminate density unevenness. An explanation will be given about unevenness of density before the explanation about the testing exposure pattern.

When film 1 is exposed by exposure section 2 and the film 1 is heat-developed by heat development section 3 to record an image, if the exposure amount is constant, the more heat quantity and the more heating time film 1 gets, the darker (higher density) it becomes, and the earlier cooling timing and the higher cooling speed film 1 gets, the lighter (lower density) it becomes.

The following four factors affect the occurrence of density unevenness at the leading edge and the trailing edge of the film 1 in the conveyance direction under the same exposure conditions.

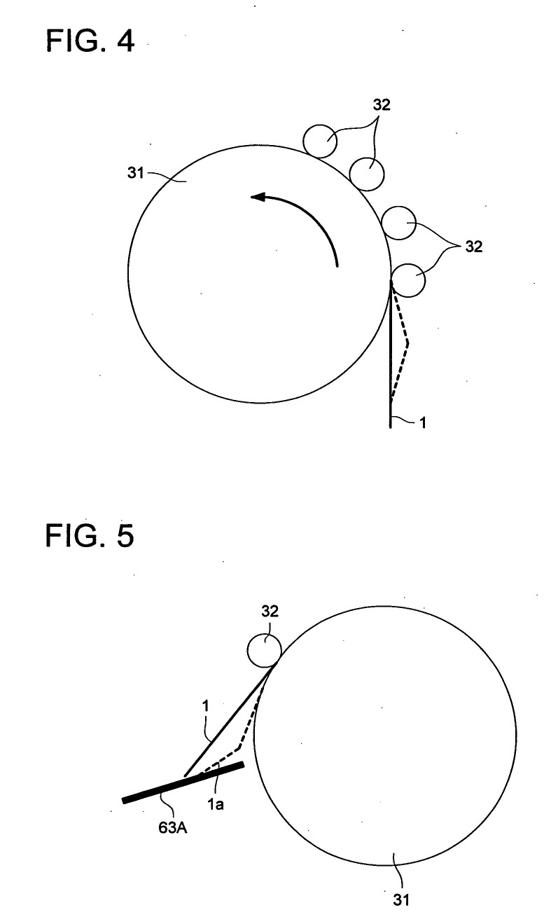

(The first factor) It occurs because of temperature difference when the film 1 gets involved with the heat roller 31. As shown in FIG. 4, the leading edge of the film 1 when it is getting involved with the heat roller 31 has a high temperature, but the other portion remain at a low temperature, resulting in a temperature difference. There is distortion (shown by the dotted line in the figure) of the film 1 due to this temperature difference, and a difference in contact ratio of the heat roller 31 at the leading edge and the other portion of the film is generated. Because the amount of heat applied to the film changes when the contact ratio changes, resulting in density unevenness.

(The second factor) It occurs because of opposing roller 32. When the film 1 is on the periphery of the heat roller 31 while receiving the pushing force from the opposing rollers 32, the film collides with a plurality of opposing rollers and is subsequently involved and conveyed. At the time of the collision, the leading edge portion of the film is lifted up and is not in contact with the heat roller 31, and thus there is difference in the received heat amount and density unevenness occurs between the leading edge portion and the other portion.

(The third factor) It occurs because of the difference in the cooling process on guide plate 63A. As specific explanation, as shown in FIG. 5, in medical image recording apparatus 1α, heat roller 31 is driven to rotate by driving motor 33, and transports film 1 after exposure while it heats the film 1. The leading edge of film 1 which has passed through the nipping points of opposing rollers 32 and heating roller 31 reaches guide plate 63A. Thereafter, the film 1 starts to take a trace 1a gradually by receiving resistance from guide plate 63A. Specifically, a portion other than the leading edge of film 1 contacts guide 63A earlier and longer than the leading edge of film 1. Since the cooling rate and cooling volume vary between cooling by guide plate 63A and cooling by atmosphere (air), density unevenness occurs.

Because film 1 is only cooled down after detachment of the film 1 from heat roller 31, if this transportation trace and transportation time are constant, no unevenness of the density of film 1 occurs, however the behavior of the leading edge of film 1 around guide plate 63A is not constant. At this point, though there is little influence from the size (aspect ratio), there is an influence of production such as a burr, projections, the direction of spreading made at the cutting stage and the direction of curl before the cutting, and there is a possibility that the transportation trace is not constant.

The trailing edge of the film 1 drops rapidly on guide plate 63A under the gravitation after detachment from heat roller 31 and it also can be a cause of variety in the cooling process.

Especially, the third factor appears clearly when it is not of a structure which keeps pulling force (it will be explained later) by having guide roller 64 and transporting roller 65.

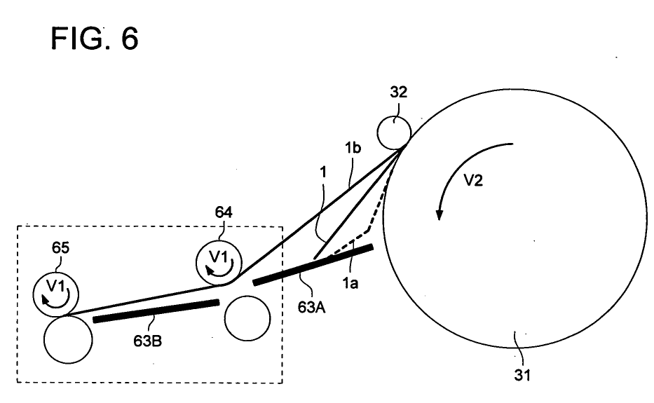

(The fourth factor) It occurs because of the difference due to the structure keeping pulling force in the cooling process. Specifically medical image recording apparatus 1α has a structure which keeps pulling force to film 1 after heat development to prevent the creation of creases as shown in FIG. 6. Heat roller 31 is driven to rotate by driving motor 33 to transport film 1 after exposure while the film is heated. Film 1 which has passed through the nip points between opposing rollers 32 and heat roller 31, reaches the nip point of transporting rollers 65 via guide plate 63A, guide roller 64 and guide plate 63B. Under the structure keeping pulling force, the relation is set to satisfy that the velocity V2 of heat roller 31<the velocity V1 of transporting roller 65. For this reason, film 1 is pulled, and the contacting pressure of the film 1 to guide plates 63A and 63B is weakened gradually on the middle portion of the film 1 in the transporting direction and eventually film 1 floats over from guide plates 63A and 63B.

The leading edge of the film 1 forms trace “1a” and the edge floats up gradually to draw trace “1b”. At this time, the cooling of film 1 by contacting guide plates 63A and 63B changes into air cooling. After the trailing edge of film 1 in the transporting direction is released from heat roller 31, film 1 continues to be transported at velocity V1. Unevenness of the density occurs because of difference of cooling process on the leading edge and the trailing edge of film 1. Especially the density on each of the leading edge and the trailing edge of film 1 is unstable compared to the middle portion of the film. Further, because velocity V1, velocity V2 and |V1−V2| also vary in each of apparatuses, the density is unstable, resulting in density unevenness.

Next, an explanation will be given regarding a testing exposure pattern to be used for calibration of the embodiment in consideration of the above factor.

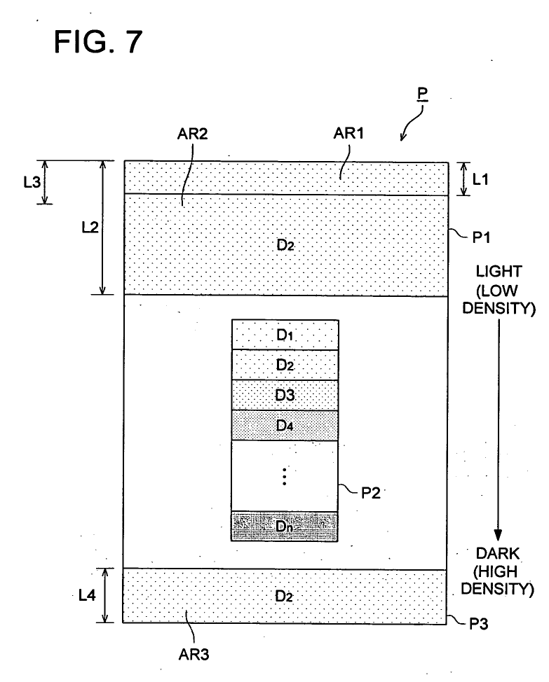

An example of testing exposure pattern P is shown in FIG. 7.

The testing exposure pattern P is a pattern of exposure amount corresponding to density pattern to be test-recorded on film 1 and it includes pattern P1 for the leading edge in the transporting direction of film 1, pattern P2 for the middle portion of film 1 and pattern P3 for the trailing edge of film. 1. Pattern P2 is a step wedge of “n” steps (“n” is an natural number) for tone correction. Pattern P2 has density levels D1 through Dn and the closer the level goes to Dn from D1, the darker (higher density) it becomes.

Pattern P1 is a solid density portion having a single density and the density of the portion is the same as one of density D1 through Dn of pattern P2. Here, for example, density D2 is employed for pattern P1. Pattern P3 is a solid density portion having a single density and the density of the portion is the same as one of density D1 through Dn of pattern P2. Here, for example, density D2 is employed for pattern P3.

The reason to make pattern P2 correspond to the middle of film 1 is that an important part of a medical image for diagnosis tends to come to the middle portion and heat development characteristic is stable compared to the leading edge and the trailing edge of film 1.

The area on the leading edge of film 1 where the density unevenness created by the second factor occurs is represented by area AR1, the area on the leading edge of film 1 where the density unevenness created by the first through the fourth factors occurs and where the area AR1 is excluded is represented by AR2, and the area on the trailing edge of film 1 where the density unevenness created by the first through the fourth factors occurs is represented by AR3. The length of area AR1 in the transporting direction is represented by L1, the length of area constituted by area AR1 and area AR2 in the transporting direction is represented by L2, the length of area on the leading edge in the transporting direction, where density unevenness occurs by the third factor is represented by L3 and the length of area AR3 in the transporting direction is represented by L4.

When a density correction is carried out on image data for output, the correction is made to the leading edge and trailing edge of film 1 (this area of correction is called correction area of the leading edge or trailing edge.). For example, length L1 is sufficient if it is at least as long as the length of a correction area in the transporting direction on the leading edge of film 1 corresponding to density unevenness created by the second factor. Length L2 is sufficient if it is at least as long as the length of a correction area in the transporting direction on the leading edge corresponding to density unevenness created by the first through the fourth factors. Length L4 is sufficient if it is at least as long as the length of a correction area in the transporting direction on the trailing edge corresponding to density unevenness created by the first through the fourth factors. For example it is structured to satisfy that Length L1 or Length (L2−L1)>>Length L3≧Pitch of opposing roller 32.

It can be structured to have different density between area AR1 and area AR2. In this structure, it is preferable that the density of area AR1 is lower than that of area AR2 and the density of area AR2 is the same as that of area AR3. For example, the density of area AR1 can be lower than that of area AR2 by one step of pattern P2. For example, the density of area AR1 may be density D1 and the density of area AR2 and AR3 may be density D2. It may be structured so that the density of area AR2 is different from that of area AR3.

Memory 150 stores correction information for 14×17 inch size sheet, correction information for 8×10 inch size sheet and correction information created for each film size by calibration (LUT, correction table for the leading edge and trailing edge and correction area information of the leading edge and trailing edge: the details of them will be described later)

The action of medical image recording apparatus 1α will now be explained.

FIG. 7 shows the calibration process. The explanation is given on the condition that patterns P1 and P3 have the same density (D2) in this example.

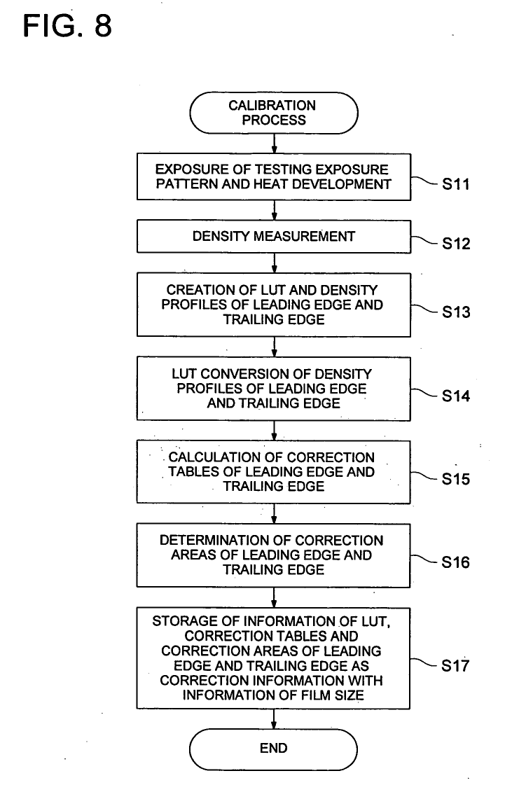

First, there will be explained the calibration process which is carried out by using one sheet of film before recording of a medical image so as to correct the density recording characteristics of medical image recording apparatus 1α, referring to FIG. 8. In medical image recording apparatus 1α, for example, input of execution indication from operation section 120 by an operator triggers CPU 110 to execute an calibration process in cooperation with calibration program which has been read out of memory 150 and has been developed in RAM 130.

First, data of testing exposure pattern P are read out of memory 150 and unrecorded film 1 sent by film conveyance section 6 is exposed to testing exposure pattern P by exposure section 2, and further, the exposed film 1 is heated and heat-developed by heat development section 3 (Step 11). Next, the density of film 1 where testing exposure pattern P has been heat-developed is measured by density measurement section 7 (Step S12). The density of each of patterns P1, P2 and P3 on film 1 is measured.

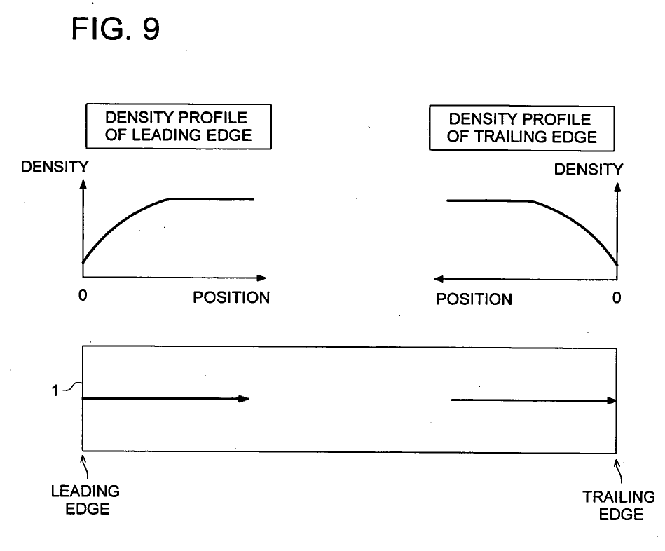

And then, based on the result of measurement of density of pattern P2, LUT (Look up table) representing the relationship between exposure amount (LD value) and diagnostic image signal (density signal (of image data)) is created for tone correction, and based on the result of measurement of density of pattern P1, a density profile of the leading edge is created, and then, based on the result of measurement of density of pattern P3, a density profile of the trailing edge is created (Step S13). FIG. 9 shows an example of density measurement for the leading edge and the trailing edge of film 1. As shown in FIG. 9, based on the result of density measurement of pattern P1, a density profile of the leading edge representing relationship between the density and the position (distance) from the leading edge of film 1 is created corresponding to pattern P1. Based on the result of density measurement of pattern P3, a density profile of the trailing edge representing relationship between the density and the position (distance) from the trailing edge of film 1 is created corresponding to pattern P3.

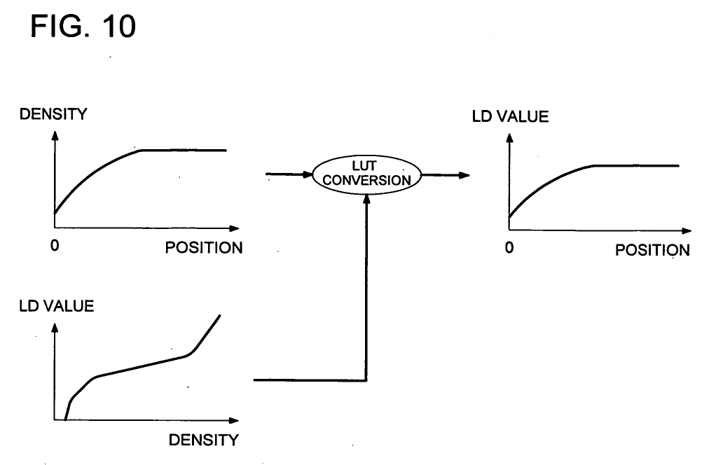

LUT conversion by using LUT created in Step 13 is applied to the density profile of the leading edge and the density profile of the trailing edge which have been created in Step 13, and the relationship between the exposure amount and the position of film 1 in the transporting direction is calculated (Step S14). FIG. 10 shows an example of calculation of relationship between the exposure amount and the position (distance) from the leading edge of film 1. For example, as shown in FIG. 10, LUT conversion is applied to a density profile of the leading edge and the relationship between the exposure amount and the position (distance) from the leading edge of film 1 is calculated.

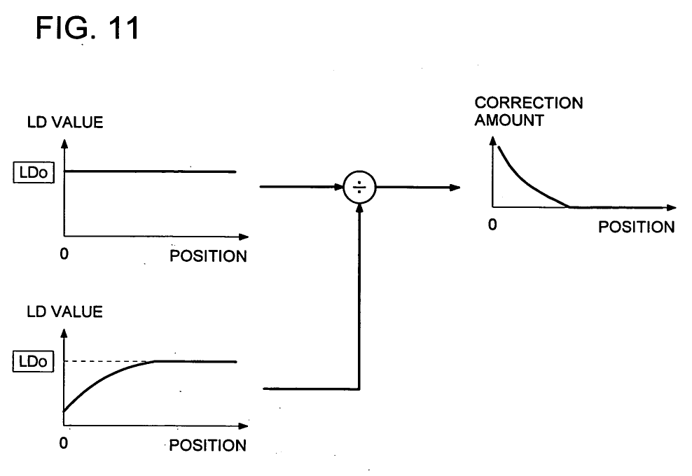

Based on the relationship between the exposure amount and the position in the transporting direction of film 1, which has been calculated in Step S14, and on predetermined density of patterns P1 and P3, a correction table of the leading edge and a correction table of the trailing edge showing the relationship between the exposure amount and the position in the transporting direction, are calculated (Step S15). FIG. 11 shows an example of calculation of a correction table of the leading edge. For example, as shown in FIG. 11, a correction table of the leading edge can be obtained by means of dividing standard exposure amount LD₀ which is constant through every position in the transporting direction of film 1 (in the example in FIG. 8, it corresponds to density D2) by the relationship of the exposure amount to the position (distance) from the leading edge of film 1. Density D2 corresponding to standard exposure amount LD₀ is included as one of plural density levels D1 through D2 in pattern P2, and the standard exposure amount (predetermined density) can be obtained easily based on the measurement result of density D2 in pattern P2.

Based on the result of density measurement of patterns P1 and P3 and the result of density measurement of pattern P2, the correction areas on the leading edge and the trailing edge of film 1 are determined (Step S16). And then, LUT calculated in Step S13, correction tables for the leading edge and the trailing edge calculated in Step S15 and correction areas for the leading edge and the trailing edge of film 1 calculated in Step 16 are stored in memory 150 (Step S17) with the film size information, as correction information to finish the calibration process. The film size information which the operator has inputted through operation section 120 is stored.

The above calibration is conducted while changing the film size. Memory 150 stores LUT for each film size and correction information such as a correction table. The film size means lengths in the width and length directions of film 1 formed rectangular, that is, the dimensions in the main scanning and sub-scanning directions and also may include the thickness of film 1.

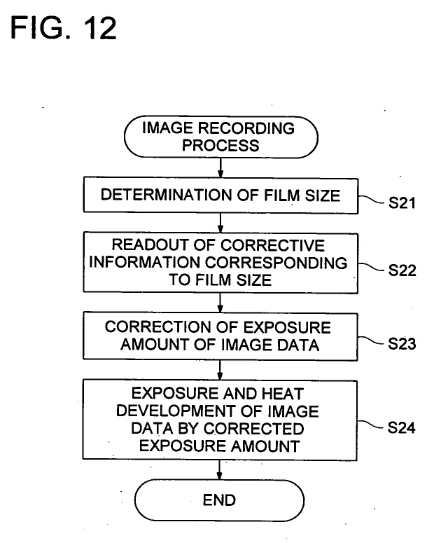

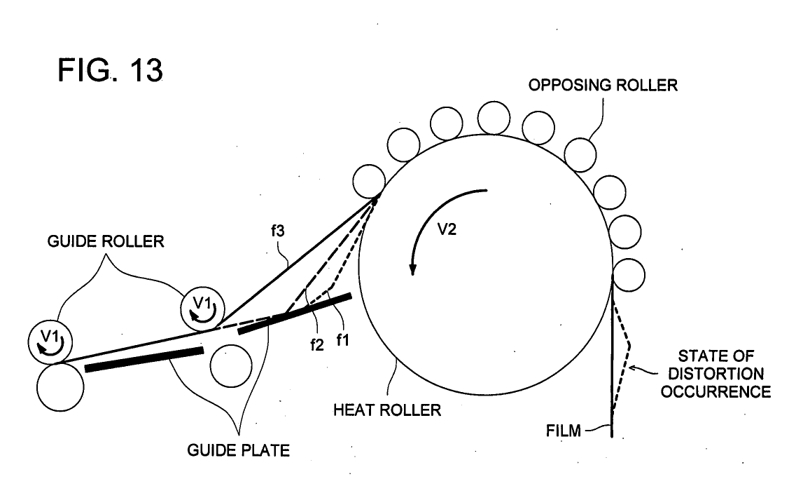

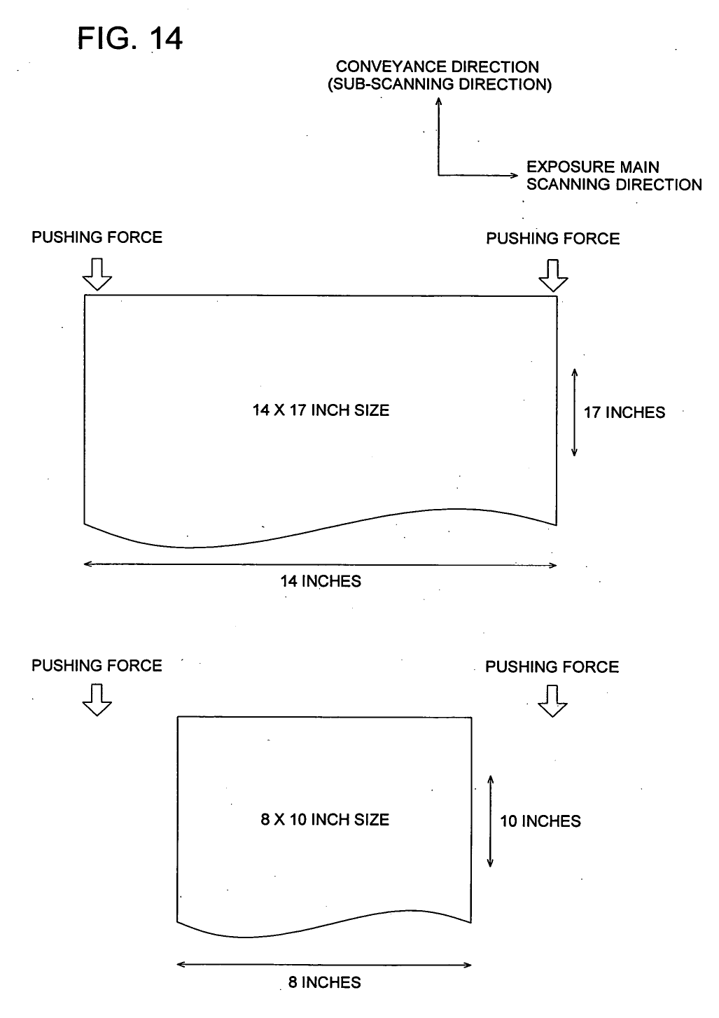

Next, an image recording process recording medical images will be explained by using LUT created in aforementioned calibration process, a correction table for the leading edge, a correction table for the trailing edge and correction areas for the leading edge and the trailing edge of film 1, in medical image recording apparatus 1α, referring to FIG. 12. FIG. 12 shows an image recording process.

In medical image recording apparatus 1α, for example, input of execution instruction for image recording from operation section 120 by an operator or reception of execution instruction for image recording via interface section 160 from outer apparatuses triggers CPU 110 to execute an image recording process in cooperation with image recording program which has been read out of memory 150 and has been developed in RAM 130.

Previously, image data of a medical image is created after radiographing body parts of patients with radiographing apparatus which is not illustrated. In medical image recording apparatus 1α, shading correction section 111 receives image data generated by radiographing from outer equipments such as radiographing apparatus and its controlling apparatus, and stores them in memory 150.

Firstly, film size is judged (Step 21), and LUT, leading edge correction table, trailing edge correction table and correction area information for the leading edge and trailing edge of film 1 which are corresponding to the film sizes are read out from memory 150 (Step S22). The film size judgment may be carried out from the input information of film size to be used which has been inputted from the operator or from the film size corresponding to the tray after operator makes a designation input for the tray to be used during image recording, if the size of films in each tray is the same and if the information of the film size in each tray is stored in memory 150. Further, when a bar code showing a film size or a type of film is provided on a film package to be loaded, information relating to a film size may be read out by reading the bar code.

Next, LUT, the correction table of the leading edge, the correction table of the trailing edge and the correction areas of the leading edge and the trailing edge of film 1 are read out of memory 150 (Step S22). A tone correction is conducted to the exposure amount of the read-out image data based on LUT read out in Step 21 and the exposure amount of the read-out image data is corrected for the correction areas on the leading edge and the trailing edge of the film 1, based on the correction table of the leading edge and the correction table of the trailing edge (Step S23).

Based on the exposure amount of image data which has been corrected in Step S23, unrecorded film 1 sent by film conveyance section 6 is exposed by exposure section 2, and exposed film 1 is heated and heat-developed by heat development section 3 to make film 1 where image data have been recorded (Step S24) visible and the image forming process is completed.

In this embodiment, because film 1 is exposed, heat-developed and applied with density measurement based on testing exposure pattern P including pattern P1 and P3, and the density characteristics of the leading edge and the trailing edge of film 1 at the recording stage of diagnostic image data are corrected for the correction areas of the leading edge and the trailing edge of film 1 based on the result of the density measurement, thereby the correction areas of the leading edge and the trailing edge of heat developable photosensitive film 1 can be determined, and the density correction can be performed accurately and efficiently. Therefore, it is possible that the correction can be done with only one film.

Since correction information is calculated for each film size, density correction can be conducted using correction information corresponding to the film size during the image recording. The image can be therefore improved because appropriate density correction is conducted even if the density unevenness has different pattern occurrence according to each film size.

Because the density characteristics of the leading edge and the trailing edge of film 1 are corrected comparing the result of density measurement of the leading edge and the trailing edge of film 1 with the result of density measurement of a pattern with the same density in step wedge of pattern P2 in the middle of the film, a difference (correcting amount of density) from the ideal density (the density to be recreated) can be detected and the density correction for the leading edge and trailing edge of film 1 can be done more accurately.

The correction areas on the leading edge and the trailing edge of the film 1 can be determined based on the heat development characteristic of heat development section 3, and the density correction for the leading edge and/or the trailing edge of film 1 can be done more accurately.

It has been known that the density characteristics of image recording performed by heat development relates to the multiplicity of exposure. The multiplicity of exposure is, for example, a parameter affected by an overlap level of an irradiated beam in the sub-scanning direction (transporting direction) of exposure. It is also possible to employ a structure in which, when one correction value of calibration (LUT, a correction table of the leading edge and a correction table of the trailing edge) of the multiplicity is created, another correction value of calibration of another multiplicity may be calculated from the correction value of calibration of multiplicity by using the characteristics of this exposure multiplicity.

The embodiment described above is one of examples of preferable medical image recording apparatuses related to this invention, however the invention is not limited to this. Regarding detailed structure and detailed operations of each constituent component of the medical image recording apparatus of the aforementioned embodiment, it is naturally possible to change them properly without departing from the spirit and scope of this invention.

For example, data of testing exposure pattern P of medical image recording apparatus 1α are recorded on a recording medium such as film 1 after they are visualized, however they may also be recorded on a recording medium such as a CD-R as digital data for preservation of the data.

LUT, a correction table of the leading edge or a correction table of the trailing edge is not limited to be one which calculates all correction values. For example, after calculation of, at least, two correction values, other correction values can be calculated by using a linear interpolation or a nonlinear interpolation method for the values already calculated.

When the size of film 1 is considered, there is a case in which all of P1, P2 and P3 cannot be included in testing exposure pattern P. In this case, it is also possible to employ an arrangement to omit pattern P3 where an area of density unevenness is smaller, compared to pattern P1.

In the aforementioned embodiment, though correction areas for the leading edge and trailing edge are determined simultaneously with the calibration process, the invention is not limited to this case. In medical image recording apparatus 1α, for example, calibration process can be structured so that the correction areas of the leading edge and trailing edge of film 1 are not determined by the calibration process, and so that after the completion of the calibration, film 1 is exposed, heat-developed and applied with density measurement based on image data of a whole or partial solid image having a prescribed single density, and then the correction areas of the leading edge and trailing edge of film 1 are determined based on the result of the density measurement. In this case, it is preferable that the determination of the correction areas is done as soon as possible after the calibration process.

In addition, in the above-described embodiment, correction information for all sizes of film 1 is obtained for both the leading edge portion and the trailing edge portion, but the density unevenness occurring at the trailing edge portion of film 1 (due to the abovementioned third and fourth factors) is hardly caused by the size of film 1, and thus it is expected that the pattern for occurrence of density unevenness will be the same for all the sizes of film 1. In this case, only correction information is obtained beforehand for the leading edge portion for each size using calibration processing, and the correction information of the trailing edge portion obtained for one size may then be applied to the other sizes.

Also, if all the sizes of the film 1 show the same density unevenness pattern also for the leading edge portion that is because of device properties of the image recording device (due to the abovementioned first and second factors), only correction information for the trailing edge portion is obtained for each size, and the correction information for the leading edge portion obtained for one size may then applied to the other film sizes.

Due to the invention, density correction can be done in accordance with film size and even in the case where the density unevenness occurs in different patterns according to the film sizes, suitable density correction can be done. As a result, an even density over the entire film surface can be obtained and image quality can be improved.

According to the invention, density unevenness occurring in different patterns for each film size in the conveyance direction of the film, in particular, can be eliminated.

Further, according to the invention, density unevenness which tends to occur due to differences in film size is eliminated at the time of conveying the film toward or away from the heat roller or due to the presence of the opposing rollers.

What is claimed is:

1. An image recording apparatus comprising:
a film retaining device which can retain at least one size of a sheet film among a plurality of sizes of sheet films which are formed by coating an emulsion including a photosensitive and a heat-sensitive recording material on a support material;
an exposure section for forming a latent image by applying scanning exposure on the film according to image data for output;
a heat development section for visualizing the latent image on the film by heating the film exposed by the exposure section; and
a shading correction section for carrying out density correction of the image data for output such that a density level of the visualized image on the film is even on an entire surface of the film,
wherein the shading correction section carries out the density correction corresponding to each size of the films.

2. The image recording apparatus of claim 1,
wherein the shading correction section carries out the density correction in a film conveyance direction of the heat development section.

3. The image recording apparatus of claim 1,
wherein the heat development section comprises a cylindrical heat roller around which the film is wound to be heated and a plurality of opposing rollers pressing the film wound around the heat roller against the heat roller.
